(19) United States
(12) Patent Application Publication
(10) Pub. No.: US 2006/0182127 A1
(43) Pub. Date: Aug. 17, 2006

(54) Apparatus and method for processing multiple protocol label switching packet

(76) Inventor: Ki-Beom Park, Suwon-si (KR)

Correspondence Address: Robert E. Bushnell, Suite 300, 1522 K Street, N.W., Washington, DC, 20005-1202, US

(21) Appl. No.: 11/336,850

(22) Filed: Jan. 23, 2006

(30) Foreign Application Priority Data
Feb. 14, 2005 (KR) 10-2005-0012058

(51) Int. Cl. H04L 12/56

(52) U.S. Cl. 370/400

(57) ABSTRACT

In an apparatus and method for processing multiple protocol label switching (MPLS) packets in MPLS networks, inclusion of a variety of information in a LABEL field is enabled by performing multiple division encoding of a LABEL field, including label information of the MPLS packets from headers of the MPLS packets. The apparatus and method for processing MPLS packets also enable information, other than the label information, to be included in an MPLS header.

### CLAIM OF PRIORITY

This application makes reference to, incorporates the same herein, and claims all benefits accruing under 35 U.S.C. § 119 from an application for APPARATUSAND METHOD FOR PROCESSING MULTIPLEPROTOCOL LABEL SWITCHING PACKET earlier filed in the Korean Intellectual Property Office on Feb. 14, 2005 and there duly assigned Serial No. 10-2005-0012058.

### BACKGROUND OF THE INVENTION

1. Technical Field

The present invention relates to an apparatus and method for processing multiple protocol label switching (MPLS) packets in MPLS networks. More particularly, the present invention relates to an apparatus and method for processing MPLS packets in MPLS networks capable of including a variety of information in an MPLS header.

2. Related Art

Since previous networks were best effort networks, there was not such a strong need for guaranteeing Quality of Service (QoS). Today, however, there are various kinds of multimedia services that require a QoS guarantee, such as Voice over Internet protocol (VoIP), videophones, video conferences, IP TVs, and Video on Demand (VoD) through networks. Furthermore, demand for such services is increasing. Items of the QoS required to provide the guarantee in networks include priority transmission and bandwidth guarantee, and technologies used to guarantee the QoS include DiffServ and MPLS.

Among the technologies used to guarantee the QoS, DiffServ is a QoS guarantee technology used in IP networks in which IP is used as a representative protocol of layer 3 protocols. The Diffserv includes a DSCP (Diffserv Code Point) field indicating service class information of a corresponding packet for the DiffServ in an IP header, and services are performed for the corresponding packet depending on class information of the DSCP field. The DSCP field can be assigned to a TOS (Type of Service) field in the case of IPv4 (IP version 4) packets, and to traffic class fields in the case of IPv6 (IP version 6) packets. More detailed descriptions of the DiffServ can be found in RFC 2475, RFC 2597, RFC 2598, and the like.

Meanwhile, MPLS is a technology wherein label information is inserted between a layer 2 header and a layer 3 header of a packet so that only the label information is checked without identifying layer 3 information, thereby ensuring rapid packet transmission in networks. Furthermore, MPLS supports a more enhanced QoS by combining advantages of existing IP technologies and connection-oriented technologies, and enables provision of various kinds of additional services, such as traffic engineering, L2/L3 (Layer2/Layer3), and VPN (Virtual Private Network).

However, if MPLS is applied to DiffServ networks, that is, if the networks to which the DiffServ technology is introduced and the MPLS networks are connected, service class (hereinafter referred to as “QoS class”) information for guaranteeing the QoS of the DiffServ networks needs to be mapped to QoS class information of the MPLS networks. If QoS class information of DiffServ packets is not mapped to QoS class information of MPLS packets, MPLS network components (for example, routers, switches, and the like) which perform a process of corresponding packets should identify IP headers that are layer 3 headers so as to identify the QoS class information of the corresponding packets.

Before describing the mapping of service classes of the DiffServ packets and the MPLS packets, a header structure of an MPLS packet will be described. General Ethernet or PPP (Point-to-Point Protocol) networks define a Shim header (hereinafter referred to as an “MPLS header”) having a size of 32 bits for MPLS label information.

A packet transmitted through an MPLS network embodied as an Ethernet may include an Ethernet header, an MPLS header, a layer 3 header, and so forth. In this regard, it is assumed that the layer 3 header is an IP header added to an IP packet according to a typical format of layer 3 packets. Service class information of DiffServ is included in the layer 3 header, i.e., the IP header and service class information of MPLS is included in the MPLS header.

The MPLS header may include a LABEL field, an EXP field, an S field, and a Time To Live (TTL) field. The LABEL field is a field in which actual label information of the corresponding MPLS packet is stored, and is assigned 20 bits. The EXP field is used to indicate a service class of DiffServ in MPLS networks, and is assigned 3 bits. The S field means “bottom of stack” and is a field in which a flag value indicating the last of the stack is stored when several labels are stacked. The S field is assigned 1 bit. The TTL field is a field in which a TTL value is stored, and is assigned 8 bits. See RFC 3032, “MPLS Label Stack Encoding” defined by MPLS Working Group (WG) of Internet Engineering Task Force (IETF) for a more detailed description of the MPLS header.

Quality of Service (QoS) guarantee in MPLS networks is performed using the EXP field among the above-described fields of the MPLS header. The EXP field is a field for supporting service classes of the DiffServ in the MPLS. A QoS classifier classifies the service classes of the MPLS within the MPLS networks using an EXP classification method.

An ingress Label Edge Router (LER) maps an existing DSCP value to an EXP value using a DSCP-to-EXP conversion table, and a transit Label Switching Router (LSR) classifies and processes service classes based on the EXP value. A method of converting the DSCP value into the EXP field in such a manner, and then classifying the service classes of packets by searching for the EXP field in an MPLS region, is referred to as an EXP inferred-PSC LSP (E-LSP), and is widely used to generally support DiffServ in transmission equipment that supports most MPLS.

However, the method of supporting DiffServ in MPLS networks using E-LSP has a problem in that a 6-bit DSCP value should be mapped to a 3-bit EXP value. In other words, since the E-LSP maps a maximum of 64 classes to a maximum of 8 classes, it cannot completely support service classes in the DiffServ networks. Furthermore, since the E-LSP maps service classes of the DiffServ and service classes of the MPLS using the DSCP-to-EXP conversion table, it has a problem in that the DSCP-EXP conversion table should be searched for an ingress LER or an egress LER.

IP packets may include Explicit Congestion Notification (ECN) information used to enhance packet transmission efficiency by indicating whether or not networks are congested. A field which includes this information is not included in the MPLS header, and therefore transmission control efficiency in the MPLS networks is reduced.

### SUMMARY OF THE INVENTION

It is, therefore, an object of the present invention to provide an apparatus and method for processing an MPLS packet that completely supports DiffServ service classes.

It is another object of the present invention to provide an apparatus and method for an MPLS packet that supports DiffServ service classes in an MPLS network without using a DSCP-to-EXP conversion table.

It is yet another object of the present invention to provide an apparatus and method for processing an MPLS packet that enables Explicit Congestion Notification (ECN) information to be used in an MPLS network.

According to an aspect of the present invention, an apparatus for processing multiple protocol label switching (MPLS) packets in a label edge router located at a border between an external network and an MPLS network comprises: a receiver for receiving a packet from the external network; a packet processor for generating an MPLS header including, in a LABEL field, a sub-field indicating a part of Quality of Service (QoS) information of the received packet, and for generating the MPLS packet by adding the MPLS header to the received packet; and a packet transmitter for transmitting the generated MPLS packet to a core network of the MPLS network.

According to another aspect of the present invention, an apparatus for processing multiple protocol label switching (MPLS) packets in a label edge router located at a border between an external network and an MPLS network comprises: a receiver for receiving a packet from the external network; a packet processor for generating an MPLS header including, in a LABEL field, a plurality of sub-fields having different information from each other, and for generating the MPLS packets by adding the MPLS header to the received packet; and a packet transmitter for transmitting the generated MPLS packet to a core network of the MPLS network.

According to still another aspect of the present invention, an apparatus for processing multiple protocol label switching (MPLS) packets in a label switching router located in an MPLS core network comprises: a packet receiver for receiving an MPLS packet from an MPLS label edge router or another label switching router; and a packet processor for determining whether or not the received MPLS packet includes a LABEL field comprising a plurality of sub-fields, and for processing the received MPLS packet depending on the result of the determination.

According to yet another aspect of the present invention, a method of processing multiple protocol label switching (MPLS) packets in a label edge router located at a border between an external network and an MPLS network comprises: receiving a packet from the external network; generating an MPLS header that includes, in a LABEL field, a plurality of sub-fields having different information from each other; and generating the MPLS packets by adding the generated MPLS header to the received packet.

According to yet another aspect of the present invention, a method of processing multiple protocol label switching (MPLS) packets in a label switching router located in an MPLS core network comprises: receiving an MPLS packet from an MPLS label edge router or another label switching router; determining whether or not the received MPLS packet includes a LABEL field having a plurality of sub-fields; and processing the received MPLS packet depending on the result of the determination.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1A is a diagram showing the general format of a multiple protocol label switching (MPLS) packet transmitted through an MPLS network embodied as an Ethernet;

FIG. 1B is a diagram showing the structure of the MPLS header shown in FIG. 1A;

FIG. 2 is a diagram showing the connection of a Non-MPLS network to an MPLS network;

FIG. 3 is a diagram showing the general format of an MPLS header including a multiple division encoded LABEL field;

FIG. 4A is a diagram showing the format of a LABEL field of Quality of Service (QoS) information through multiple division encoding in accordance with an embodiment of the present invention;

FIG. 4B is a diagram showing mapping to generate QoS information of a corresponding packet from QoS information included in a LABEL field and QoS information included in an EXP field in an MPLS header including the LABEL field of the format shown in FIG. 4A;

FIG. 5A is a diagram showing a LABEL field that further includes Explicit Congestion Notification (ECN) information in the MPLS header shown in FIG. 4A in accordance with another embodiment of the present invention;

FIG. 5B is a diagram showing mapping to generate QoS information of a corresponding packet from QoS information and ECN information included in a LABEL field, and QoS information included in an EXP field, in an MPLS header including the LABEL field of the format shown in FIG. 5A;

FIG. 6A is a configuration diagram of an MPLS packet processing apparatus for performing multiplexing division encoding, in accordance with the present invention, in a Label Edge Router;

FIG. 6B is a configuration diagram of a label management unit included in FIG. 6A;

FIG. 6C is a configuration diagram of an MPLS packet processing apparatus for performing multiplexing division encoding, in accordance with the present invention, in a Label Switching Router;

FIG. 7 is a flowchart showing multiplexing division encoding in the Label Edge Router in accordance with an embodiment of the present invention; and

FIG. 8 is a flowchart showing an MPLS packet processing procedure in a Label Switching Router in accordance with another embodiment of the present invention.

### DETAILED DESCRIPTION OF THE INVENTION

The present invention will now be described more fully with reference to the accompanying drawings, in which preferred embodiments of the invention are shown.

The present invention described hereinafter indicates service classes of multiple protocol label switching (MPLS) packets and Explicit Congestion Notification (ECN) information using a LABEL field of an MPLS header. That is, the present invention divides the LABEL field of the MPLS header, uses a part of the LABEL field to indicate label information of corresponding packets, and uses a remaining part of the LABEL field to indicate DiffServ service classes and ECN information. Hereinafter, a method of dividing one field so as to include a variety of information as described above is referred as “multiple division encoding”. Of course, the present invention can be extended and applied so that the LABEL field further includes information other than label information, DiffServ service class information, and ECN information. Furthermore, the present invention maybe extended in order that multiple division encodings for fields other than the label field can be performed.

The present invention will now be described with reference to an embodiment using multiple division encoding for the LABEL field of the MPLS header. The LABEL field is used because it constitutes the largest part of the MPLS header. Since the size of the LABEL field is 20 bits, the MPLS label can be assigned in the region of 0 to 2²⁰−1, i.e., 0 to 1048575. Except for the values 0 to 15, which are previously defined for special uses, the label value region capable of assigning actual MPLS network components is 16 to 1048575. However, generally, a label region of more than one million is regarded as unnecessarily large. Therefore, a part of the LABEL field may include packet information other than label information through multiple division encoding in accordance with the present invention. One example of other packet information that can be included in the LABEL field is QoS class information.

Before describing the mapping of service classes of the DiffServ packets and the MPLS packets, the header structure of an MPLS packet will be described. General Ethernet or PPP (Point-to-Point Protocol) networks define a Shim header (hereinafter referred to as an “MPLS header”) having a size of 32 bits for MPLS label information. The MPLS header will be described with reference to the accompanying drawings.

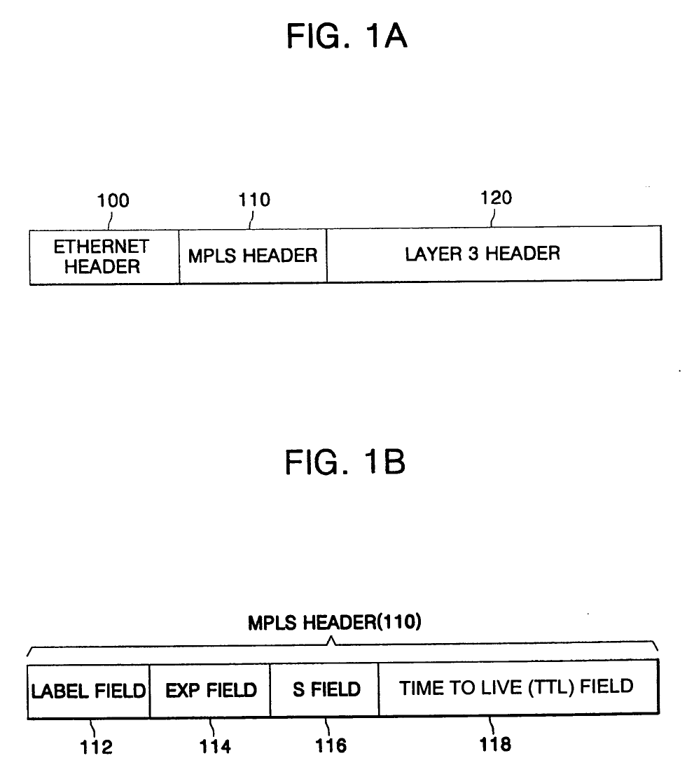

FIG. 1A is a diagram showing the general format of an MPLS packet transmitted through an MPLS network embodied as an Ethernet.

As shown in FIG. 1A, the packet transmitted through the MPLS network embodied as the Ethernet may include an Ethernet header 100, an MPLS header 110, a layer 3 header 120, and the like. Here, it is assumed that the layer 3 header 120 is an IP header added to an IP packet according to a typical format of layer 3 packets. Service class information of DiffServ is included in the layer 3 header 120, i.e., the IP header and service class information of MPLS are included in the MPLS header 110.

FIG. 1B is a diagram showing the structure of the MPLS header shown in FIG. 1A.

As shown in FIG. 1B, the MPLS header 110 may include a LABEL field 112, an EXP field 114, an S field 116, and a Time To Live (TTL) field 118. The LABEL field 112 is a field in which actual label information of the corresponding MPLS packet is stored, and is assigned 20 bits. The EXP field 114 is used to indicate a service class of DiffServ in MPLS networks, and is assigned 3 bits. The S field 116 means “bottom of stack”, and is a field in which a flag value indicating the last of the stack is stored when several labels are stacked. The S field 116 is assigned 1 bit. The TTL field 118 is a field in which a TTL value is stored, and is assigned 8 bits. See RFC 3032, “MPLS Label Stack Encoding” defined by MPLS Working Group (WG) of Internet Engineering Task Force (IETF) for a more detailed description of the MPLS header.

Quality of Service (QoS) guarantee in MPLS networks is performed using the EXP field 114 among the above-described fields of the MPLS header. The EXP field 114 is a field for supporting service classes of the DiffServ in the MPLS. A QoS classifier classifies the service classes of the MPLS within the MPLS networks using an EXP classification method.

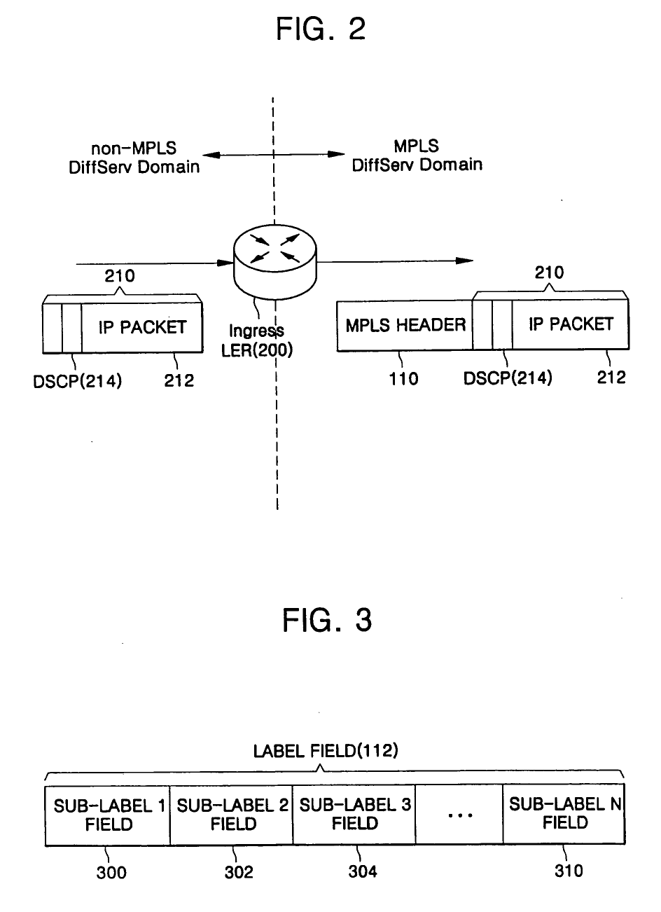

FIG. 2 is a diagram showing the connection of a non-MPLS network to an MPLS network. More particularly, FIG. 2 shows the mappings of a DiffServ service class and an MPLS service class to support DiffServ in MPLS networks defined by RFC 3270.

As shown in FIG. 2, an ingress LER (Label Edge Router) 200 maps an existing DSCP value 214 in packet 210 to an EXP value using a DSCP-to-EXP conversion table (not shown), and a transit LSR (Label Switching Router) classifies and processes service classes based on the EXP value. A method of converting the DSCP value 214 into the EXP field in such a manner, and then classifying the service classes of IP packets 212 by searching for the EXP field in an MPLS region, is referred to as an EXP inferred-PSC LSP (E-LSP), and is widely used to generally support DiffServ in transmission equipment that supports most MPLS.

However, the method of supporting the DiffServ in the MPLS networks using the E-LSP has a problem in that a 6-bit DSCP value 214 should be mapped to a 3-bit EXP value. In other words, since the E-LSP maps a maximum of 64 classes to a maximum of 8 classes, it cannot completely support service classes in the DiffServ networks. Furthermore, since the E-LSP maps service classes of the DiffServ and service classes of the MPLS using the DSCP-to-EXP conversion table, it has a problem in that the DSCP-EXP conversion table should be searched for an ingress LER or an egress LER.

IP packets 212 may include ECN information used to enhance packet transmission efficiency by indicating whether or not networks are congested. The field including this information is not included in the MPLS header 110, and therefore transmission control efficiency in the MPLS networks is reduced.

General multiple division encoding of the label field 112 will be described with reference to the accompanying drawings.

FIG. 3 is a diagram showing the general format of an MPLS header including a multiple division encoded LABEL field.

Referring to FIG. 3, the LABEL field 112 can be divided into a plurality of sub-label fields (sub-label 1 field to sub-label N field) 300 to 310 through multiple division encoding in accordance with the present invention. Each of sub-label fields can include different information in a corresponding packet. Of course, the plurality of sub-label fields should include one or more fields indicating label information of the corresponding packet. The “sub-label fields” are generated as a result of multiple division encoding for the label field 112.

Multiple division encoding of the LABEL field 112 will now be described with reference to a detailed embodiment.

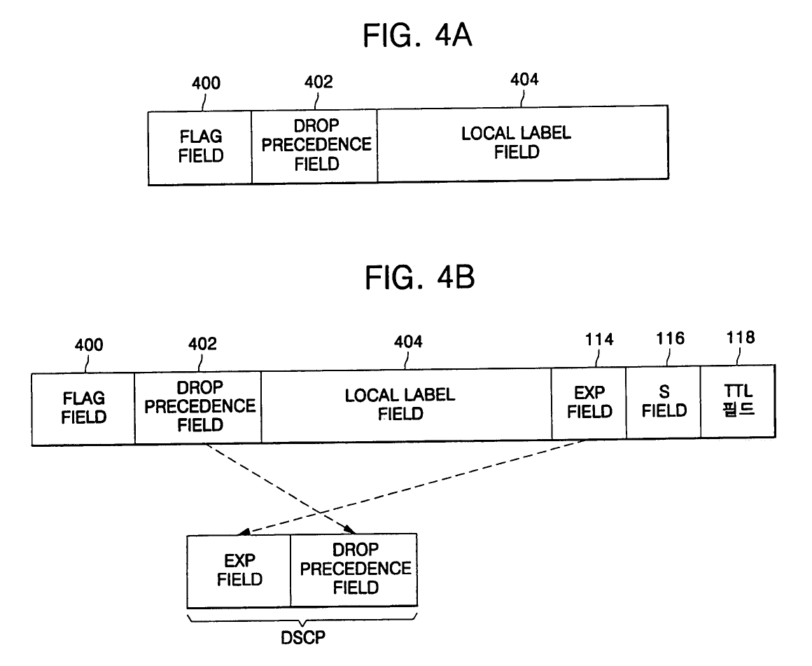

FIG. 4A is a diagram showing the format of a LABEL field of Quality of Service (QoS) information through multiple division encoding in accordance with an embodiment of the present invention.

Referring to FIG. 4A, a LABEL field can be multiple division encoded into a FLAG field 400, a DROP PRECEDENCE field 402, and a LOCAL LABEL field 404. The FLAG field 400 is a sub-label field indicating whether or not a multiple division encoding method was used. That is, the FLAG field 400 is used to indicate whether or not the corresponding MPLS packet is a multiple division encoded packet. Generally, the FLAG field 400 can have a size of 1 bit. The DROP PRECEDENCE field 402 is a sub-label field including QoS information of the corresponding MPLS packet. The DROP PRECEDENCE field 402 can have a size of 3 bits. The LOCAL LABEL field 404 is a sub-label field including label information of the corresponding MPLS packet. The size of LOCAL LABEL field 404 can be 16 bits, corresponding to the number of bits remaining after subtracting 1 bit assigned to the flag field 400 and 3 bits assigned to the DROP PRECEDENCE field 402 from the 20 bits of the label field 112. Generally, 2¹⁶−1 (65535) is a sufficient value to express label information of the MPLS packet. As shown in FIG. 4A, the multiple division encoded MPLS packet has divided QoS class information and includes the divided information in the DROP PRECEDENCE field 402 and the EXP field 114 of the label field of the MPLS header. Therefore, in order to identify QoS class information of the corresponding MPLS packet, all information included in the DROP PRECEDENCE field 402 and the EXP field 114 of the label field should be considered.

FIG. 4B is a diagram showing mapping to generate QoS information of a corresponding packet from QoS information included in a LABEL field and QoS information included in an EXP field in an MPLS header including the LABEL field of the format shown in FIG. 4A

In particular, FIG. 4B shows mapping of an example wherein the first 3 bits among 6 bits of DSCP information of an IP header are included in the EXP field 114, and the remaining 3 bits are included in the DROP PRECEDENCE field 402. It is also possible for the MPLS packet to express QoS class information according to complete DSCP information by considering both the EXP field 114 and the DROP PRECEDENCE field 402, as shown in FIGS. 4A and 4B. That is, by using multiple division encoding according to the present invention, it is possible to express a variety of QoS classes in the MPLS packet, and to express and confirm the QoS class without a specific DSCP-to-EXP mapping procedure.

Another embodiment of the present invention will now be described with reference to the accompanying drawings.

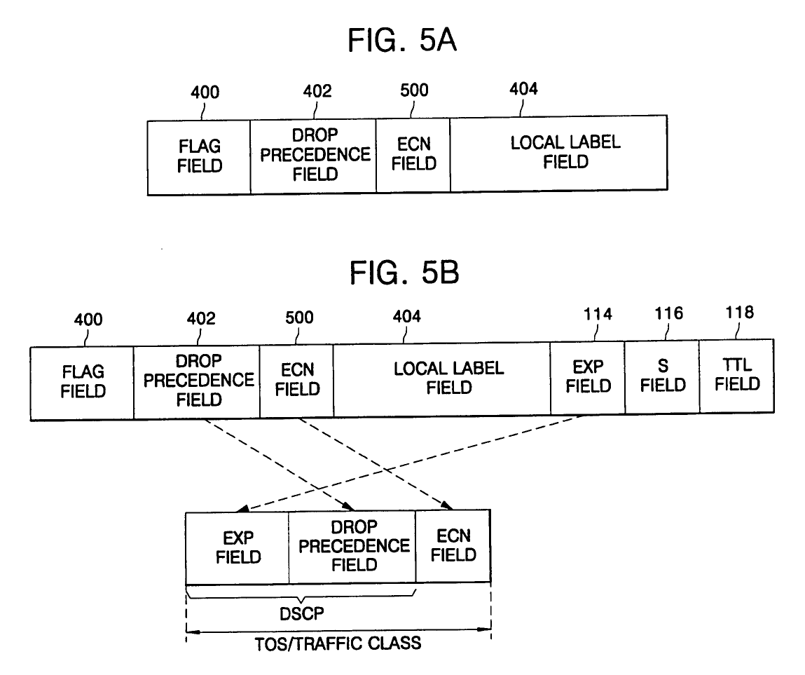

FIG. 5A is a diagram showing a LABEL field that further includes Explicit Congestion Notification (ECN) information in the MPLS header shown in FIG. 4A in accordance with another embodiment of the present invention.

Referring to FIG. 5A, the LABEL field can be multiple division encoded into a FLAG field 400, a DROP PRECEDENCE field 402, an ECN field 500, and a LOCAL LABEL field 404. The ECN field 500 is a sub-field which includes information indicating whether or not corresponding packets have collided. The ECN field 500 can have a size of 2 bits. The FLAG field 400, the DROP PRECECENCE field 402, and the LOCAL LABEL field 404 are described above with reference to FIG. 4A. The LABEL field shown in FIG. 5A further includes ECN information in the ECN field 500. The size of the LOCAL LABEL field 404 can be 14 bits, corresponding to the result of subtracting 1 bit assigned to the flag field 400, 3 bits assigned to the DROP PRECEDENCE field 402, and 2 bits assigned to the ECN field 500 from the 20 bits of the label field 112. Generally, 2¹⁴−1 (16383) is a sufficient value to express label information of the MPLS packet.

FIG. 5B is a diagram showing mapping to generate QoS information of a corresponding packet from QoS information and ECN information included in a LABEL field, and QoS information included in an EXP field, in an MPLS header including the LABEL field of the format shown in FIG. 5A.

Referring to FIG. 5B, the EXP field 114 and the DROP PRECEDENCE field 402 of the MPLS header include QoS class information of the MPLS packet corresponding to DSCP information of the IP packet, and the ECN field 500 includes information corresponding to ECN information of the IP packet. Accordingly, it is possible to express QoS class information and ECN information of the IP packet, even in the MPLS packet, through multiple division encoding in accordance with the present invention. The EXP field 114, the DROP PRECEDENCE field 402, and the ECN field 500 of the MPLS packet are information corresponding to a TOS field of an IPv4 packet or a traffic class field of an IPv6 packet.

An MPLS packet processing apparatus will now be described, wherein each of a plurality of MPLS network components can perform packet processing in accordance with the multiple division encoding of FIGS. 3 to 5B for the received MPLS packet. The present invention will be described below with reference to an embodiment which uses a router as an example of an MPLS network component. An MPLS router can be classified into a Label Edge Router located at a border between the MPLS network and another network (hereinafter referred to as an “external network”), and a Label Switching Router located at a core of the MPLS network that is not connected to the external network. The Label Edge Router is different from the Label Switching Router in that, in processing the MPLS packet, the Label Edge Router includes a procedure for generating an MPLS packet by adding the MPLS header to the packet received from the external network, and a procedure for removing the MPLS header of the MPLS packet received from the Label Switching Router and transmitting it to an external network. The MPLS packet processing apparatus in the Label Edge Router will be described first.

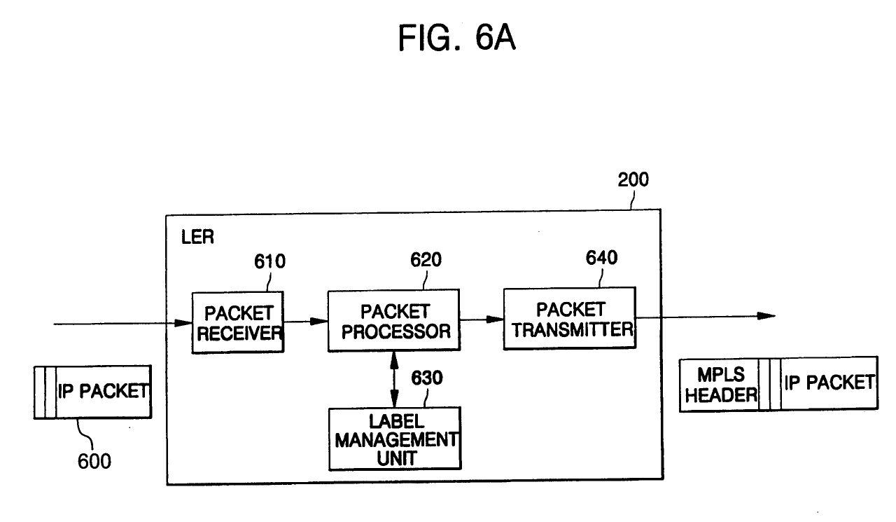

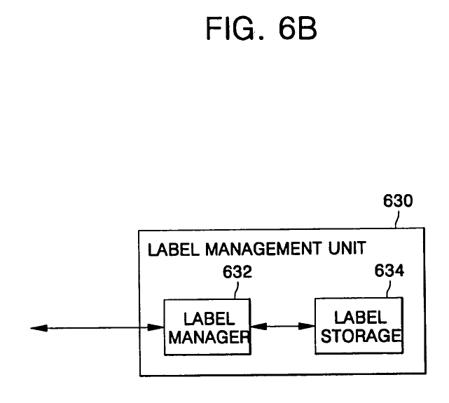

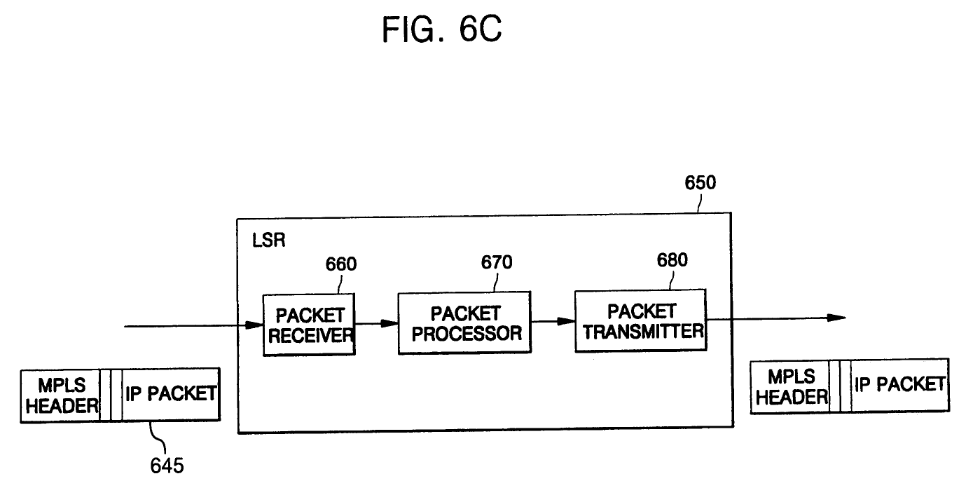

FIG. 6A is a configuration diagram of an MPLS packet processing apparatus for performing multiple division encoding, in accordance with the present invention, in a Label Edge Router.

The Label Edge Router (LER) 200 should be able to generate the MPLS header to be added to a packet (an IP packet, for example) received from an external network. For this, it is necessary to assign label information to be included in the MPLS header. Of course, the Label Edge Router 200 should be able to perform multiple division encoding in the generation of the MPLS header in order to apply the apparatus to the present invention. As shown in FIG. 6A, in accordance with the present invention, the Label Edge Router 200 includes a packet receiver 610, a packet processor 620, a label management unit 630, and a packet transmitter 640. In particular, FIG. 6A shows the processing of an IP packet 600 received from an external network. The packet receiver 610 receives packets 600 from the external network or the Label Switching Router. The packet processor 620 adds the MPLS header to the packet received from the external network, or removes the MPLS header from the MPLS packet received from the Label Switching Router. The label management unit 630 manages label information to be assigned to the packet received from the external network. The packet transmitter 640 transmits the processed packet to the external network or Label Switching Router.

The processing of a packet 600, received from the external network, in the packet processor 620 will be described in detail. When receiving a packet 600 from the external network, the packet processor 620 generates the MPLS header to be added to a corresponding packet. At this point, the packet processor 620 generates a multiple division encoded MPLS header. That is, the packet processor 620 divides the LABEL field 112 into a plurality of sub-fields, and includes information indicating whether or not multiple division encoding is used, QoS class information, ECN information, and the like, in each sub-field. Of course, the LABEL field 112 should include a sub-field to express label information of the corresponding packet. Meanwhile, the packet processor 620 requires the label management unit 630 to assign an MPLS label for each packet when generating the MPLS header.

FIG. 6B is a configuration diagram of a label management unit included in FIG. 6A.

The label management unit 630 can include a label manager 632 and a label storage 634. The label storage 634 stores assignable labels, and can have the form of a pool. The label manager 632 outputs the assignable labels stored in the label storage 634 to the packet processor 620 in accordance with a label assignment request from the packet processor 620. At this point, the quantity of labels which can be assigned by the label manager 632 depends on establishment of a system showing how the multiple division encoding is performed. For example, the label management unit 630 may assign as many as 2²⁰−1 or 2¹⁶⁻¹ labels.

FIG. 6C is a configuration diagram of an MPLS packet processing apparatus for performing multiple division encoding, in accordance with the present invention, in a Label Switching Router.

Referring to FIG. 6C, the Label Switching Router 645 comprises a packet receiver 660, a packet processor 670, and a packet transmitter 680. The packet receiver 660 receives the MPLS packet 645 from the Label Edge Router or another Label Switching Router. The packet processor 670 identifies a header of the received MPLS packet 645, and performs packet processing required by the MPLS header. The packet processing performed in the packet processor 670 includes transmission of a corresponding packet to the requested next router, providing service according to a requested QoS class, and the like. The packet processor 670 can process both an MPLS packet which is multiple division encoded, and an MPLS packet which is not multiple division encoded. The packet processor 670 can determine whether or not the corresponding MPLS packet is a multiple division encoded MPLS packet through the FLAG field 400. The packet transmitter 680 transmits the corresponding packet to another Label Switching Router or a Label Edge Router.

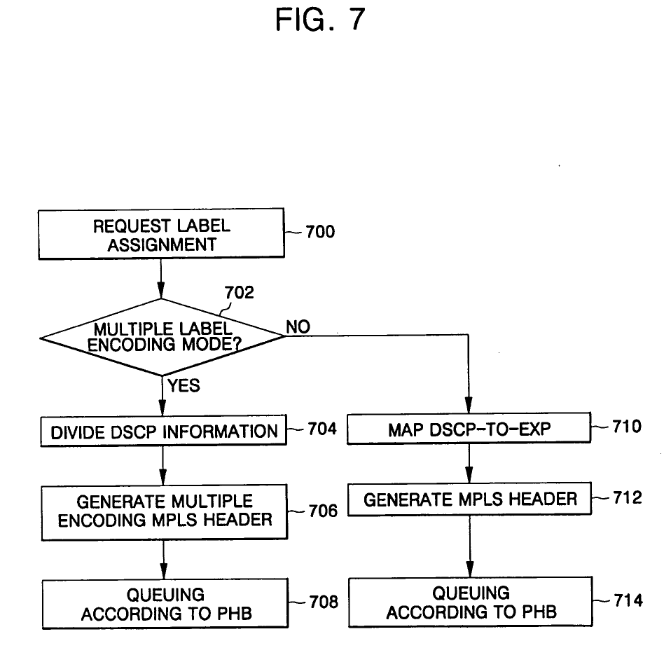

FIG. 7 is a flowchart showing multiple division encoding in the Label Edge Router in accordance with an embodiment of the present invention.

The MPLS packet processing apparatus in LER 200, in accordance with the present invention, requests a label assignment for a packet received from an external network in step 700.

If a multiple division encoding mode for the received packet is being performed (step 702), the MPLS packet processing apparatus in LER 200 divides the DSCP information included in the received packet (in step 704), and includes a part of the divided information in the EXP field 114 of the MPLS header, and a remaining part of the information in the DROP PRECEDENCE field 402, which is one of the sub-label fields. In step 706, the MPLS packet processing apparatus in LER 200 generates the MPLS header by including the label information assigned at the LOCAL LABEL field 404, which is another sub-label field of the multiple division encoded LABEL field 112 of the MPLS header. Of course, the LABEL field 112 of the MPLS header generated at this time includes the FLAG field 400, which is a sub-field indicating that the corresponding LABEL field 112 is multiple division encoded. The MPLS packet processing apparatus of LER 200 performs queuing according to requirements, such as PHB (Per Hop Behavior) and the like, in step 708. The PHB is a priority control method, for example, EF PHB (Expedited Forwarding PHB) defined in RFC 2598 and AF PHB (Assured Forwarding PHB) defined in RFC 2597. The EF PHB assigns a prior packet transmission processing operation, and the AF PHB assigns a packet transmission guarantee type operation.

Accordingly, it is possible to express QoS class information and ECN information of the IP packet, even in the MPLS packet, through multiple division encoding in accordance with the present invention.

Meanwhile, if a multiple division encoding mode for the received packets is not performed, the MPLS packet processing apparatus of LER 200 performs a DSCP-to-EXP mapping for the received packets in step 710. In step 712, the MPLS packet processing apparatus of LER 200 generates an MPLS header, including label information assigned in step 700 and QoS class information obtained through the DSCP-to-EXP mapping in step 710. The MPLS packet processing apparatus of LER 200 performs queuing according to the PHB in step 714.

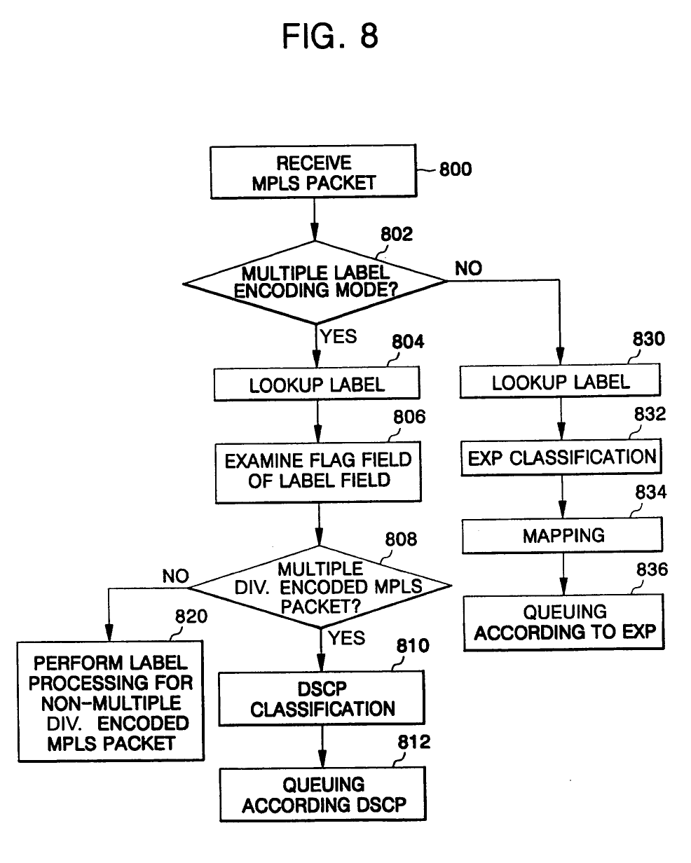

FIG. 8 is a flowchart showing an MPLS packet processing procedure in a Label Switching Router in accordance with another embodiment of the present invention.

The MPLS packet processing apparatus in the Label Switching Router (LSR) 650, in accordance with the present invention, receives the MPLS packet from the Label Edge Router 200 or another Label Edge Router in step 800.

If the MPLS packet processing apparatus of LSR 650 is currently in the multiple label encoding mode (step 802), the apparatus of LSR 650 performs a label lookup for the received MPLS packet in step 804. The MPLS packet processing apparatus of LSR 650 examines the FLAG field 400 of the LABEL field 112 included in the MPLS header of the received MPLS packet in step 806. The MPLS packet processing apparatus of LSR 650 determines whether or not the corresponding packet is a multiple division encoded MPLS packet as a result of examining the FLAG field 400 in step 808. When the corresponding MPLS packet is a multiple division encoded MPLS packet, the MPLS packet processing apparatus of LSR 650 performs DSCP classification for the corresponding MPLS packet in step 810. The MPLS packet processing apparatus of LSR 650 performs queuing according to the result of the DSCP classification performed for the corresponding MPLS packet in step 812.

If the corresponding MPLS packet is determined to be an MPLS packet that was not multiple division encoded in step 808, the MPLS packet processing apparatus of LSR 650 performs label processing for non-multiple division encoded MPLS packets in step 820.

Meanwhile, when the MPLS packet processing apparatus of LSR 650 is determined (in step 802) not to be in the multiple label encoding mode, it performs a label lookup for the corresponding MPLS packet in step 830, and classification according to information included in the EXP field 114 of the corresponding MPLS packet in step 832. In step 834, the MPLS packet processing apparatus of LSR 650 performs DSCP-to-EXP mapping using the result of the EXP classification performed in step 832. In step 836, the MPLS packet processing apparatus of LSR 650 performs the MPLS packet queuing according to the mapping result in step 834.

According to the present invention as described above, it is possible to support the service class of DiffServ in the MPLS network without using the DSCP-to-EXP conversion table, and to support a service class of the packet introduced into the MPLS network from an external network. Furthermore, according to the present invention, it is possible to include ECN (Explicit Congestion Notification) information of a packet introduced into the MPLS network from an external network in the MPLS packet.

While the present invention has been described with reference to exemplary embodiments thereof, it will be understood by those skilled in the art that various changes in form and detail may be made therein without departing from the scope of the present invention as defined by the following claims.

What is claimed is:

1. An apparatus for processing multiple protocol label switching (MPLS) packets in a label edge router located at a border between an external network and an MPLS network, the apparatus comprising:
a receiver for receiving a packet from the external network;
a packet processor for generating an MPLS header including a LABEL field having a sub-field indicating a part of Quality of Service (QoS) information of the received packet, and for generating the MPLS packet by adding the MPLS header to the received packet; and
a packet transmitter for transmitting the generated MPLS packet to a core network of the MPLS network.

2. The apparatus according claim 1, wherein the packet processor includes a part of QoS class information of the received packet in an EXP field, and a part of the QoS class information that is not included in the EXP field in a sub-field of the LABEL field.

3. The apparatus according to claim 2, wherein, the packet processor includes, in the EXP field, 3 bits of 6 bits of DiffServ Code Point (DSCP) information which is the QoS class information of the received packet, and includes a remaining 3 bits of the 6 bits of the DSCP information in the sub-field of the LABEL field.

4. The apparatus according to claim 3, wherein the received packet is an IPv4 packet.

5. The apparatus according to claim 4, wherein the DSCP information of the received IPv4 packet is included in a Type of Service (TOS) field of an IPv4 header.

6. The apparatus according to claim 3, wherein the received packet is an IPv6 packet.

7. The apparatus according to claim 6, wherein the DSCP information of the received IPv6 packet is included in a Traffic Class field of an IPv6 header.

8. The apparatus according to claim 1, wherein the LABEL field of the generated MPLS header further includes a sub-field indicating information comprising Explicit Congestion Notification (ECN) information of the received packet.

9. The apparatus according to claim 1, wherein the LABEL field of the generated MPLS header further includes a sub-field indicating whether the LABEL field includes a plurality of sub-fields.

10. The apparatus according to claim 1, wherein the LABEL field includes a sub-field including label information assigned to a corresponding packet.

11. The apparatus according to claim 1, further comprising a label management unit for assigning a label to be included in the MPLS header when generation of the MPLS header to be added to the packet received from the packet processor is requested.

12. The apparatus according to claim 11, wherein the label management unit comprises:
a label storage for storing labels that are assignable to the received packet; and
a label manager for searching for the label storage, and for assigning a LABEL field of the MPLS header to be added to a received field when label assignment of the MPLS header to be added to the packet received from the packet processor is requested.

13. The apparatus according to claim 12, wherein an assignable label is determined depending on a size of a sub-field to be used in order to indicate label information assigned to the received packet.

14. An apparatus for processing multiple protocol label switching (MPLS) packets in a label edge router located at a border between an external network and an MPLS network, the apparatus comprising:
a receiver for receiving a packet from the external network;
a packet processor for generating an MPLS header including a LABEL field having a plurality of sub-fields, each sub-field having different respective information, and for generating the MPLS packets by adding the MPLS header to the received packet; and
a packet transmitter for transmitting the generated MPLS packet to a core network of the MPLS network.

15. An apparatus for processing multiple protocol label switching (MPLS) packets in a label switching router located in an MPLS core network, the apparatus comprising:
a packet receiver for receiving an MPLS packet from one of an MPLS label edge router and another label switching router; and
a packet processor for determining whether the received MPLS packet includes a LABEL field comprising a plurality of sub-fields, and for processing the received MPLS packet depending on the result of the determination.

16. A method of processing multiple protocol label switching (MPLS) packets in a label edge router located at a border between an external network and an MPLS network, the method comprising the steps of:
receiving a packet from the external network;
generating an MPLS header which includes a LABEL field having a plurality of sub-fields, each sub-field having different respective information; and
generating the MPLS packets by adding the generated MPLS header to the received packet.

17. A method of processing multiple protocol label switching (MPLS) packets in a label switching router located in an MPLS core network, the method comprising the steps of:
receiving an MPLS packet from an MPLS label edge router or another label switching router;
determining whether the received MPLS packet includes a LABEL field having a plurality of sub-fields; and
processing the received MPLS packet depending on the result of the determination.
